(19) United States
(12) Patent Application Publication
(10) Pub. No.: US 2006/0244320 A1
(43) Pub. Date: Nov. 2, 2006

(54) Brushless motor having coreless assembly

(76) Inventors: Dong-Liang Guo, Jiaxing City (CN); Kang Lu, Jiaxing City (CN); Min-Huang Lin, Jiaxing City (CN); Ta-Chun Song, Jiaxing City (CN)

Correspondence Address: TROXELL LAW OFFICE PLLC, SUITE 1404, 5205 LEESBURG PIKE, FALLS CHURCH, VA, 22041, US

(21) Appl. No.: 11/117,372

(22) Filed: Apr. 29, 2005

(51) Int. Cl. B60K 1/00; H02K 11/00

(52) U.S. Cl. 310/68 B; 310/154.06; 310/268; 180/65.1; 180/65.5

(57) ABSTRACT

The present invention provides a brushless motor with a sensor unit, which is coreless-assembled and is of simple structure with high usage efficiency, no iron loss and small mechanical loss.

### FIELD OF THE INVENTION

The present invention relates to a brushless motor; more particularly, relates to a brushless motor of simple structure, high usage efficiency, no iron loss and small mechanical loss.

### DESCRIPTION OF THE RELATED ART

The efficiency of a DC motor according to a prior art depends on its iron loss as well as its mechanical loss. The iron loss is a loss happened when a current is passing through an armature and can be obtained by the resistance and the current rating of the armature. The rotor can be stuck by the resistance of the armature to be prevented from rotating, while the two ends of the armature are connected to a DC power supplier. The power supplied can be increased till the current of the armature reaches its current rating, where the resistance of the armature is the ratio of the applied voltage to the current of the armature. Hence, a coreless motor without a silicon steel plate is of no iron loss. Besides, when a DC motor is in an idle rotation at a speed rating, the input power is equal to the mechanical loss at that specific speed out of its idle rotation; when the DC motor is with loads and its rotation speed is kept around the rotation speed measured when without loads, the mechanical loss is equal to the idle rotation loss. Consequently, with no silicon steel plate, a coreless motor produces no end voltage as what does with loads; and, as the current of the rotor is small, the mechanical loss is small too.

Please refer to FIG. 9, which is a cross-sectional view of a coreless motor according to a prior art, disclosed in the patent of U.S. Pat. No. 3,993,920, “Coreless motor”. As shown in the figure, the coreless motor comprises a case 5 with a bearing 6, a rotor 7 with a flat coil 71 and a stator 8 with a fixed field, where the stator 8 is corresponding to the rotor 7 and a rotary field is formed by using a brush 9.

Although a coreless motor can be obtained according the prior art stated above, the stator 8 of the coreless motor is corresponding to the flat coil 71 only at an end while no field stopper is corresponding to the other end of the flat coil 71. As a result, its magnetic circuit is not shortened on operating so that it produces more hysteresis loss and mechanical loss yet less usage efficiency. In addition, the structure of the rotor 7 is more complex so that it takes more working hours and working processes. So, the prior art does not fulfill users' requests on actual use.

### SUMMARY OF THE INVENTION

Therefore, the main purpose of the present invention is to obtain a motor of high power density and of high rotation speed while with a simple structure, a high usage-efficiency, no iron loss and a small mechanical loss.

To achieve the above purpose, the present invention is a brushless motor having coreless assembly, comprising a motor, a sensor unit, an inverter and a control unit. Therein, the motor comprises a case; an axle of movability penetrates the case at the center; a coreless wound stator is deposed on the axle; a collar plate deposed in the case is respectively corresponding to each end of the coreless wound stator; and, a permanent magnet corresponding to the coreless wound stator is deposed on at lease one collar plate. The sensor unit can sense the state of the magnetic pole of the coreless wound stator which is corresponding to the permanent magnet. The inverter is connected to the sensor unit to obtain the state of the magnetic pole to control the field commutating time of the coreless wound stator. And, the control unit is located between and connected to the motor and the inverter so that a loop is formed to control the rotation speed of the motor. Accordingly, a novel brushless motor having coreless assembly is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view according to a preferred embodiment of the present invention;

FIG. 2 is an explosive view of a first preferred embodiment of a motor according to the present invention;

FIG. 3 is a cross-sectional view of the first preferred embodiment of a motor according to the present invention;

FIG. 4 is a cross-sectional view of a second preferred embodiment of a motor according to the present invention;

FIG. 5 is a perspective view showing a sensor unit for back electromotive force according to another preferred embodiment of the present invention;

FIG. 6 is a view of an open loop control according to the present invention;

FIG. 7 is a view of a close loop control according to the present invention;

FIG. 8 is a cross-sectional view of a third preferred embodiment of a motor according to the present invention; and

FIG. 9 is a cross-sectional view of a coreless motor according to a prior art.

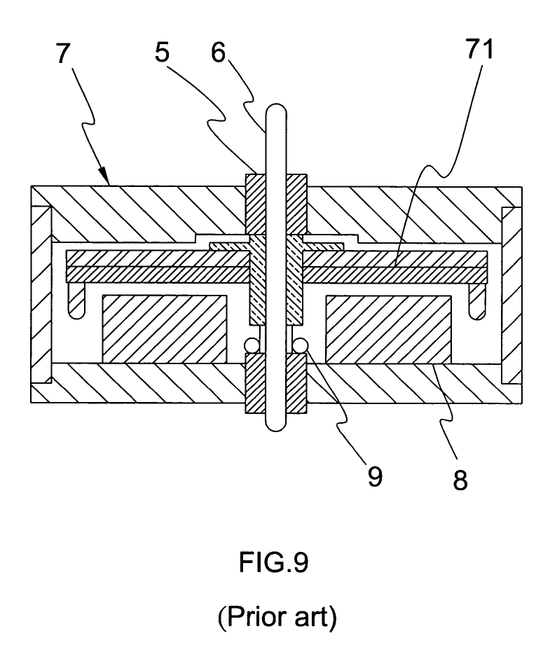

### DESCRIPTION OF THE PREFERRED EMBODIMENTS

The following descriptions of the preferred embodiments are provided to understand the features and the structures of the present invention.

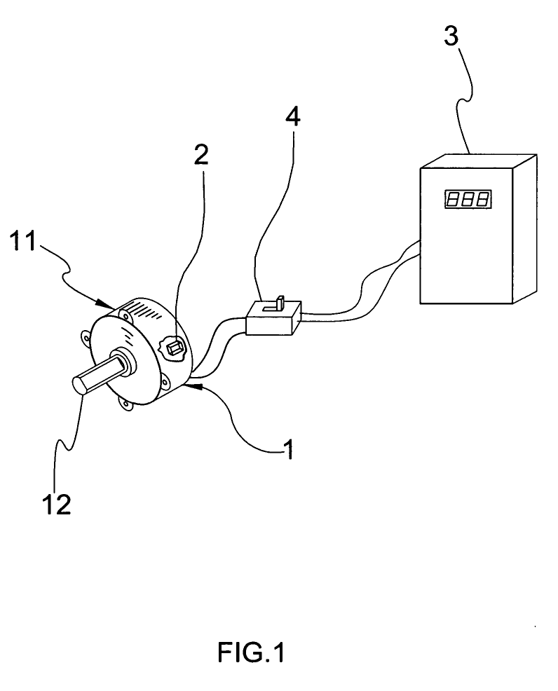

Please refer to FIG. 1, which is a perspective view according to a preferred embodiment of the present invention. As shown in the figure, the present invention is a brushless motor having coreless assembly, comprising a motor 1, a sensor unit 2, an inverter 3, and a control unit 4, where the motor 1 is characterized in high power density and high rotation speed while its structure is simple, its usage efficiency is high, and it is of no iron loss as well as of small mechanical loss.

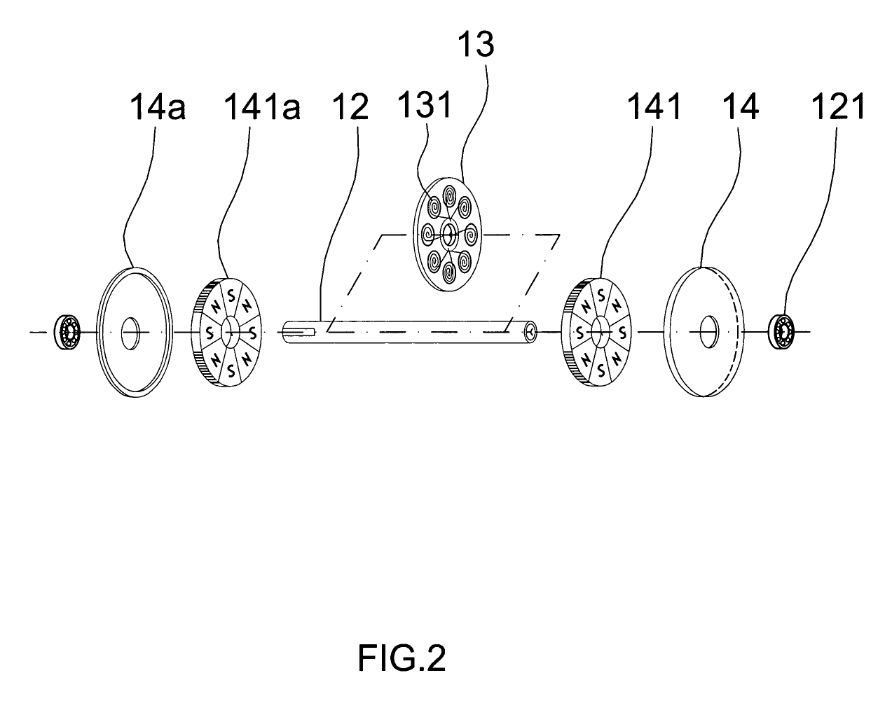

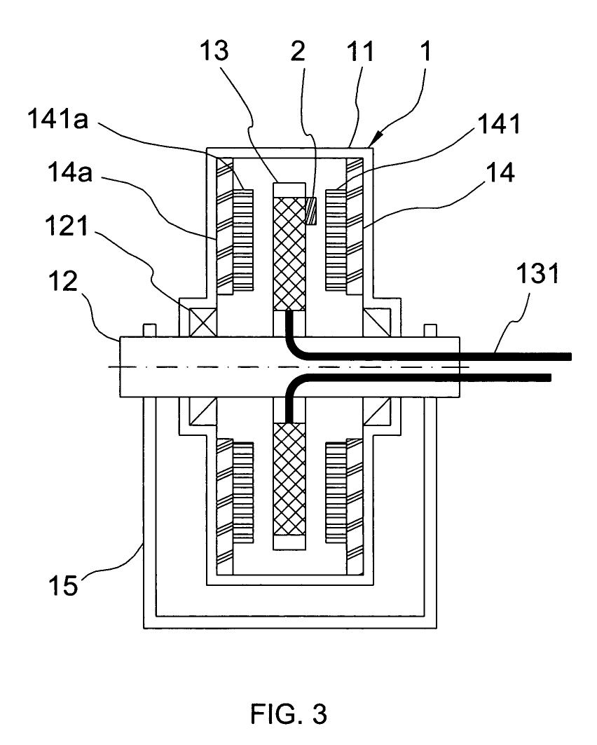

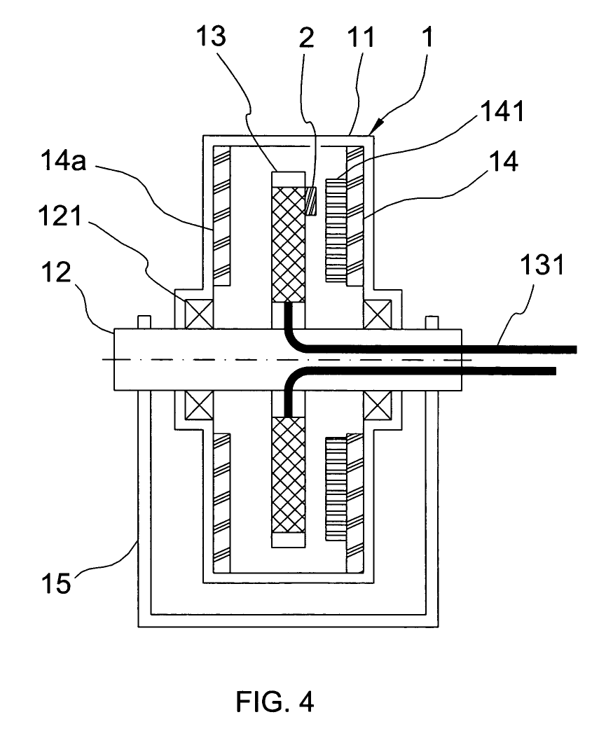

Please refer to FIG. 2 through FIG. 4 in addition, which are an explosive view and a cross-sectional view of the first preferred embodiment of a motor, and a cross-sectional views of a second preferred embodiments of a motor, according to the present invention. As shown in the figures, the motor 1 comprises a case 11; an axle 12 of movability penetrates the case 11 at the center; a bearing 121 is located respectively between the case 11 and each end of the axle 12; a coreless wound stator 13 is deposed on the axle 12; a collar plate 14, 14a is deposed in the case 11 and is respectively corresponding to each end of the coreless wound stator 13; a permanent magnet 141 corresponding to the coreless wound stator 13 is deposed on one collar plate 4, or two permanent magnets 141, 141a on both collar plates 14, 14a (as shown in FIG. 2 and FIG. 3), to keep a shortest magnetic circuit to the axle; the coreless wound stator 13 is connected with a coil 131 which can obtain an outside power source; and the axle 12 is deposed on a supportive frame at its own two ends. The sensor unit 2 can be set on the coreless wound stator 13 (as shown in FIG. 3 and FIG. 4) for sensing the state of the magnetic pole of the coreless wound stator 13 which is corresponding to the permanent magnet 141. The inverter 3 is connected to the sensor unit 2 to obtain the state of the magnetic pole of the coreless wound stator 13 sensed by the sensor unit 2 to control the field commutating time of the coreless wound stator 13. And, the control unit 4 is located between and connected to the motor 1 and the inverter 3 so that a loop is formed to control the rotation speed of the motor 1. In the end, a novel brushless motor having coreless assembly is obtained.

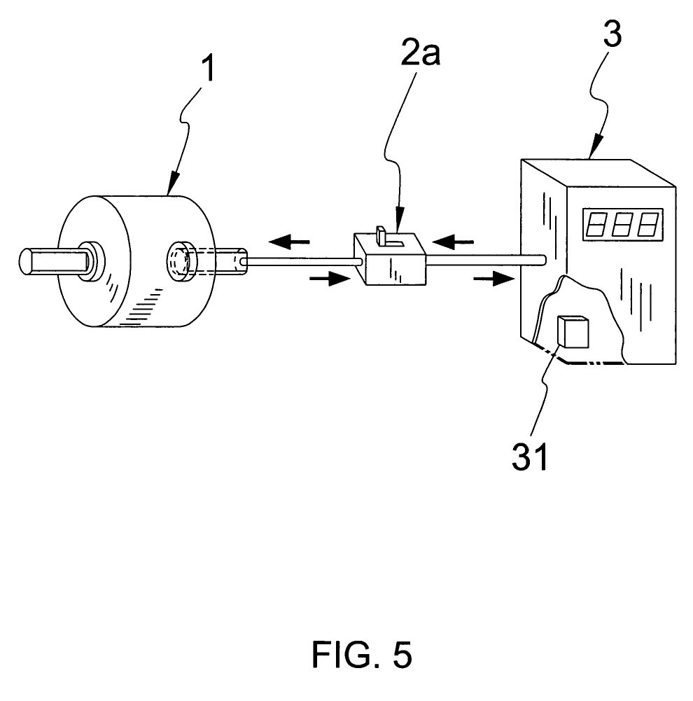

Please refer to FIG. 5, which is a perspective view showing a sensor unit for back electromotive force according to another preferred embodiment of the present invention. As shown in the figure, a sensor unit 2a can sense a commutation of a coreless wound stator (not shown in the figure) by a back electromotive force; and, when the sensor unit 2a senses the commutation of the coreless wound stator by the back electromotive force, the state of the magnetic pole of the coreless wound stator is sensed. At the same time, an inverter 3 is comprised with a detecting unit 31 to acquire the state of the magnetic pole of the coreless wound stator together with the back electromotive force so that the field commutating time of the coreless wound stator 13 can be controlled.

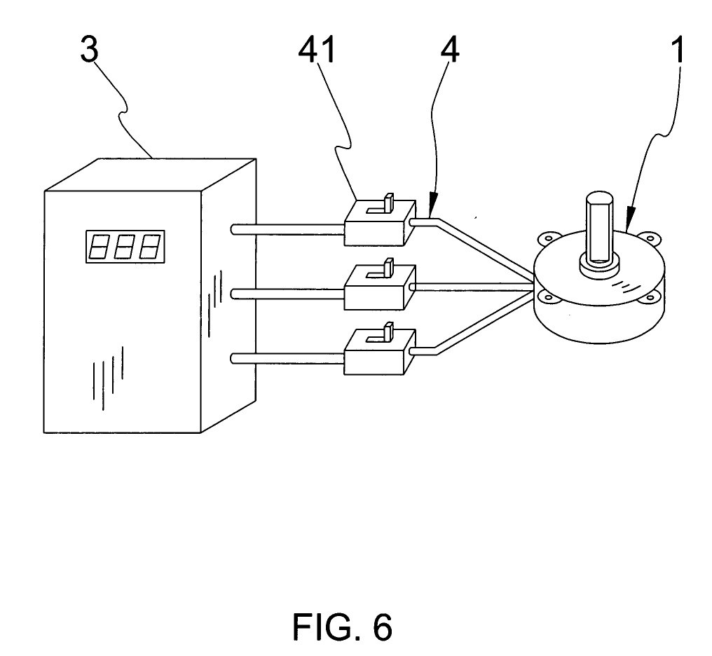

Please refer to FIG. 6, which is a view of an open loop control according to the present invention. As shown in the figure, in an actual application, a control unit 4 according to the present invention can comprises a plurality of switchers 41 with setup values for speed, such as speeds of 300 rpm (revolutions per minute), 600 rpm and 1200 rpm, to control the rotation speed of a motor 1, where an open loop control can be formed by the motor 1, an inverter 3 and the control unit 4. When operating, the user turns on the required switcher 41 to form a loop with the motor 1, the inverter 3 and the switcher 41 so that the motor 1 can reach the required speed according to the setup value of speed for the switcher 41 the user turns on.

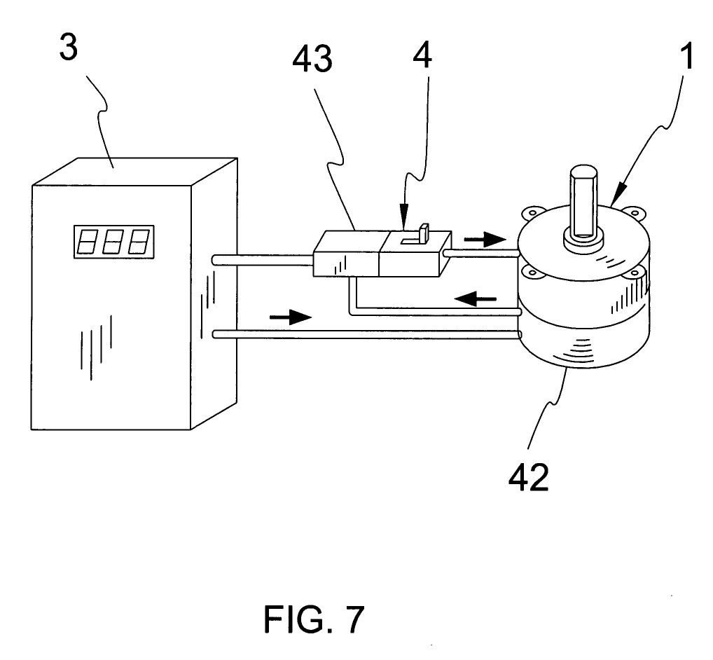

Please refer to FIG. 7, which is a view of a close loop control according to the present invention. As shown in the figure, except forming an open loop control as shown in FIG. 6, a control unit 4 can comprise a tachometer 42 connected with an axle 12 of a motor 1, and a differential amplifier 43 connected to the switcher 41 and an inverter 3, so that a close loop control is formed by the motor, the inverter 3 and the control unit 4. When operating, a value for rotation speed is setup in the differential amplifier 43. As the motor 1 is turned on and powered, it is rotated in a speed according to the setup value. According to the rotation speed of the motor 1 reported promptly and continuously in the feedbacks of the tachometer 42 to the differential amplifier 43, the rotation speed error to the setup rotation speed is analyzed. If the error amount is getting smaller, the commutation speed is turned smaller by the inverter 3 so that the rotation speed can reach the setup value. On the contrary, if the error amount is getting bigger, the commutation speed is turned greater by the inverter 3 so that the rotation speed can reach the setup value.

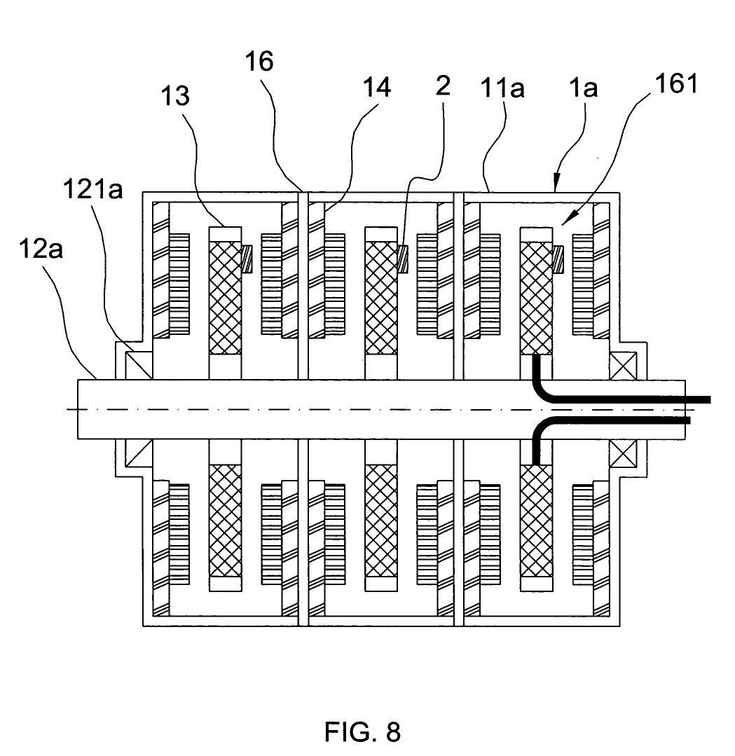

Please refer to FIG. 8, which is a cross-sectional view of a third preferred embodiment of a motor according to the present invention. As shown in the figure, a plurality of metal partitions 16 is deposed in a case 11a of a motor 1a to form a plurality of rooms 161 in the case 11a. An axle 12a penetrates the plurality of metal partitions 16; and, a plurality of coreless wound stators 13 is deposed on the axle 12a and each wound stator 13 is located respectively in a room 161. In addition, a permanent magnet 14 is respectively corresponding to the coreless wound stator 13 at each end surface of each metal partition as forming a series, which can better fulfill a certain request on an actual use.

To sum up, the present invention is a brushless motor having coreless assembly, where the motor is characterized in high power density and high rotation speed while its structure is simple, its usage efficiency is high, and it is of no iron loss as well as of small mechanical loss.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A brushless motor having coreless assembly, comprising:
a motor, said motor comprising a case, said case penetrated by an axle of movability at center of said case, a coreless wound stator deposed on said axle, a collar plate located in said case, said collar plate respectively corresponding to each end surface of said coreless wound stator, a permanent magnet deposed on at least one said collar plate, said permanent magnet corresponding to said coreless wound stator;
a sensor unit, said sensor unit sensing a state of a magnetic pole of said coreless wound stator;
an inverter, said inverter connected with said sensor unit to obtain said state of said magnetic pole sensed of said magnetic pole of said coreless wound stator by said sensor unit to control a field commutating time of said coreless wound stator; and
a control unit, said control unit located between and connected to said motor and said inverter to form a loop to control a rotation speed of said motor.

2. The brushless motor according to claim 1, wherein a bearing is respectively located between said case and each end of said axle.

3. The brushless motor according to claim 1, wherein said axle is deposed on a supportive frame at two ends of said axle.

4. The brushless motor according to claim 1, wherein said sensor unit comprises a positioning sensor selected from a group consisting of a Hall element and a photo positioning sensor.

5. The brushless motor according to claim 1, wherein said sensor unit is deposed on said coreless wound stator.

6. The brushless motor according to claim 1,
wherein a commutation of said coreless wound stator is sensed by said sensor unit through a back electromotive force to control a field commutating time of said coreless wound stator; and
wherein said inverter comprises a detecting unit to be informed of said back electromotive force.

7. The brushless motor according to claim 1,
wherein said control unit comprises a plurality of switchers to control a rotation speed of said motor; and
wherein an open loop control is formed by said motor, said inverter and said control unit.

8. The brushless motor according to claim 1,
wherein said control unit comprises a tachometer and a differential amplifier connected with said tachometer;
wherein said differential amplifier is connected to said motor and said inverter;
wherein said tachometer is connected with said axle of said motor; and
wherein a close loop control is formed by said motor, said inverter and said control unit.

9. The brushless motor according to claim 1,
wherein more than one metal partition is deposed in said case to obtain a plurality of rooms;
wherein said plurality of rooms is penetrated by an axle;
wherein more than one coreless wound stator is deposed on said axle and is respectively located in each said room; and
wherein a permanent magnet is respectively corresponding to each said coreless wound stator at each of two end surfaces of each said metal partition.
